(19) United States
(12) Patent Application Publication
(10) Pub. No.: US 2017/0087927 A1
(43) Pub. Date: Mar. 30, 2017

(54) LAYERED PRODUCT

(71) Applicant: Asahi Glass Company, Limited, Chiyoda-ku (JP)

(72) Inventors: Misa INAMOTO, Chiyoda-ku (JP); Takashi SHIBUYA, Chiyoda-ku (JP); Yoichi SERA, Chiyoda-ku (JP); Takashi OKADA, Chiyoda-ku (JP)

(73) Assignee: Asahi Glass Company, Limited, Chiyoda-ku (JP)

(21) Appl. No.: 15/375,717

(22) Filed: Dec. 12, 2016

Related U.S. Application Data
(63) Continuation of application No. PCT/JP2015/067072, filed on Jun. 12, 2015.

(30) Foreign Application Priority Data
Jun. 20, 2014 (JP) 2014-127453

(51) Int. Cl. B44F 1/02; G02B 5/28; B44C 3/02; B44F 1/06; C23F 1/00; B32B 15/04

(52) U.S. Cl. CPC B44F 1/02; C23F 1/00; B32B 15/04; B44C 3/02; B44F 1/06; G02B 5/286

(57) ABSTRACT

A layered product includes a substrate including a first surface and second surface that face each other, wherein the layered product includes a metal film on the first surface of the substrate, wherein gaps are dispersed between the substrate and the metal film, the gaps optically affecting light in a visible light region, wherein, when the layered product is measured from the second surface of the substrate, an absorption ratio with respect to visible light, the absorption ratio being an average value in a range of wavelength from 400 nm to 700 nm, is greater than or equal to 50%, reflectance, the reflectance being an average value in a range of wavelength from 400 nm to 700 nm, is less than or equal to 40%, and brightness L* of a D65 light source in a visual field of 10 degrees is less than or equal to 70.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2015/067072 filed on Jun. 12, 2015 and designating the U.S., which claims priority of Japanese Patent Application No. 2014-127453 filed on Jun. 20, 2014. The entire contents of the foregoing applications are incorporated herein by reference.

### BACKGROUND OF THE INVENTION

1. Field of the Invention

The present disclosure relates to a substrate and a layered product with a metal film.

2. Description of the Related Art

Recently, in various fields, a decorating technique has been focused on that is to be applied to a product with a layered product. For example, even for a product provided with the same function, by changing, for example, color of the layered product, a difference can be provided in an impression, such as luxury or appearance of the product, and thereby consumer's purchasing motivation can be enhanced.

For example, in Patent Document 1 (Japanese Unexamined Patent Publication No. 2010-201652), a technique has been proposed such that, when it is viewed in one viewing angle, interference colors, such as iris colors, are generated by reflection and transmission of visible light, and thereby decorativeness of a layered product can be enhanced.

In Patent Document 1, in order to enhance decorativeness of a layered product, interference colors are generated by laminating a multiple number of thin films on a cloudy plate.

In contrast, depending on a purpose of decoration of a layered product, there may be a case where it is demanded that no large change in color occurs no matter in which angle the layered product is viewed, and that the layered product always presents the same color.

According to the technique of Patent Document 1, however, it is difficult to suppress angle dependence of the color of the layered product.

Furthermore, in the technique of Patent Document 1, in order to produce a desired interference color, it is required to control the film thickness of each layer forming the multilayer film highly accurately, so that the manufacturing process is extremely complicated.

There is a need for a layered product that can be manufactured by a relatively easy method, and that can significantly suppress angle dependence of the color.

### SUMMARY OF THE INVENTION

According to an aspect of the present invention, there is provided a layered product including a substrate, wherein the substrate includes a first surface and second surface that face each other, wherein the layered product includes a metal film on a side of the first surface of the substrate, wherein gaps are dispersed between the substrate and the metal film, the gaps optically affecting light in a visible light region, wherein, when the layered product is measured from a side of the second surface of the substrate, an absorption ratio with respect to visible light (an average value in a range of wavelength from 400 nm to 700 nm) is greater than or equal to 50%, reflectance (an average value in a range of wavelength from 400 nm to 700 nm) is less than or equal to 40%, and brightness L* of a D65 light source in a visual field of 10 degrees is less than or equal to 70.

According to an embodiment, there can be provided a layered product that can be manufactured by a relatively easy method, and that can significantly suppress angle dependence of color.

### BRIEF DESCRIPTION OF THE DRAWINGS

FIG. 1 is a diagram schematically illustrating a cross section of a layered product according to an embodiment of the present invention;

FIG. 2 is a diagram (a scanning electron microscope (SEM) photograph) illustrating an example of an upper surface of the layered product according to the embodiment of the present invention;

FIG. 3 is a diagram schematically illustrating a cross section of another layered product according to the embodiment of the present invention;

FIG. 4 is a diagram schematically illustrating a flow of a method of manufacturing the layered product according to the embodiment of the present invention;

FIG. 5 is a diagram illustrating an example of a configuration of a processing device for implementing an etching process of a glass substrate in a state in which the glass substrate is conveyed;

FIG. 6 is a cross-sectional SEM photograph of the layered product according to a fourth example;

FIG. 7 is a graph illustrating wavelength dependence of reflectance R that is measured in the layered product according to example 21; and

FIG. 8 is a graph illustrating wavelength dependence of the reflectance R that is measured in the layered product according to example 29.

### DESCRIPTION OF THE PREFERRED EMBODIMENTS

An embodiment of the present invention is described below in detail.

As described above, depending on a purpose of decoration of a layered product, there is a case where it is demanded that no large change in color occurs no matter in which angle the layered product is viewed, and that the layered product always presents the same color.

However, according to the technique of Patent Document 1, it is difficult to suppress angle dependence of color of the layered product. Furthermore, in the technique of Patent Document 1, it is required to control the film thickness of each layer forming the multilayer film highly accurately, so that the manufacturing process is extremely complicated.

In contrast, according to the embodiment of the present invention, there is provided a layered product including a substrate wherein the substrate includes a first surface and second surface that face each other, wherein the layered product includes a metal film on a side of the first surface of the substrate, wherein gaps are dispersed between the substrate and the metal film, the gaps optically affecting light in a visible light region, wherein, when the layered product is measured from a side of the second surface of the substrate, an absorption ratio with respect to visible light (an average value in a range of wavelength from 400 nm to 700 nm) is greater than or equal to 50%, reflectance (an average value in a range of wavelength from 400 nm to 700 nm) is less than or equal to 40%, and brightness L* of a D65 light source in a visual field of 10 degrees is less than or equal to 70.

In such a layered product, by the effect of the gaps dispersed between the substrate and the metal film, angle dependence of color that is obtained when the layered product is viewed from the side of the substrate can be significantly suppressed.

Further, in the layered product, each color can be presented by a corresponding single layer metal film. Accordingly, it is not required to form a multilayer film in which the thickness of each layer is highly accurately controlled, as in Patent Document 1; and a layered product for decoration can be manufactured by a relatively simple process.

The gaps dispersed between the substrate and the metal film may be formed, for example, by applying an etching process to the first surface of the substrate. For example, for a case where the substrate is a glass substrate, the first surface may be etched by hydrofluoric acid.

Here, in the present application, colors are denoted in accordance with color coordinates of the L*a*b* display system based on JIS 28729. Here L is brightness, and a* and b* are chromaticity, respectively.

Furthermore, in the present application, chroma C is defined by using chromaticities a* and b*, respectively. Namely, chroma C is represented by

C=\sqrt{(a*)²(b*)²} formula (1)

In the layered product according to the embodiment of the present invention, it is preferable that absolute values of the chromaticities a* and b* of a light source D65 in a visual field of 10 degrees respectively be less than or equal to 40; and more preferably less than or equal to 30.

In the layered product according to the embodiment of the present invention, for a case where such small chromaticities a* and b* are selected, the layered product is seen to have a specific absorption color, such as a black color, a brown color, or a gray color, without metallic luster when the layered product is viewed from the side of the second surface of the layered product in any angle. Accordingly, if, for example, a metal observed to be blackish is used for such a layered product, it is advantageous for applying to the decoration of an outer peripheral part of a display for which a black-based color is preferable, such as a black color where L*≦50. Note that, as L* becomes smaller, the color becomes darker, and it becomes easier to be recognized to be a black color with respect to surrounding.

(Layered Product According to the Embodiment of the Present Invention)

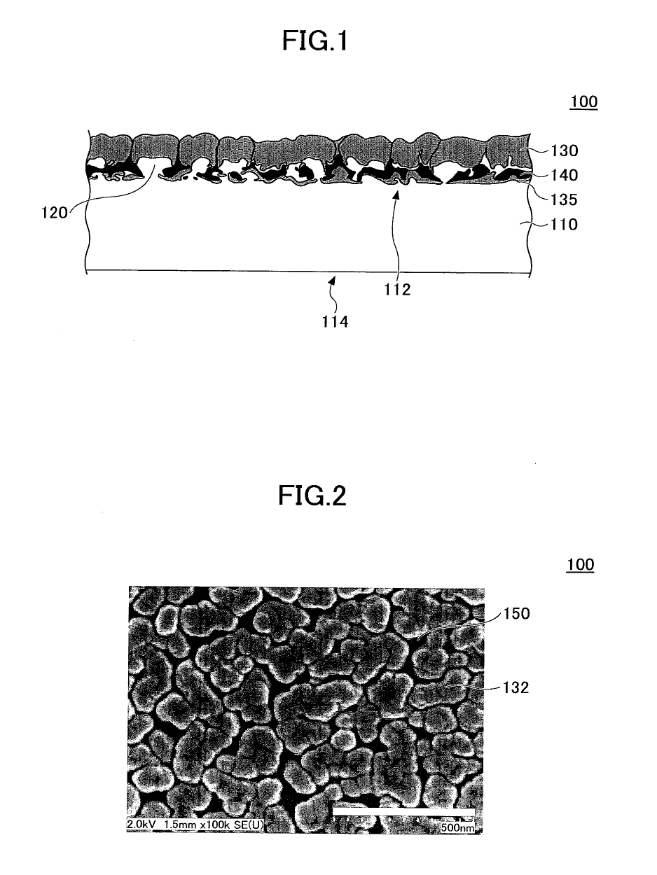

Next, by referring to FIG. 1 and FIG. 2, the layered product according to the embodiment of the present invention is described.

FIG. 1 schematically illustrates a cross section of the layered product according to the embodiment of the present invention (which is referred to as the “first layered product,” hereinafter). Furthermore, FIG. 2 illustrates an example of a top view (an SEM photograph) of the first layered product.

As illustrated in FIG. 1, the first layered product 100 includes a substrate 110; and a metal film 130.

The substrate 110 includes a first surface 112, and a second surface 114; and the metal film 130 is located at a side of the first surface 112 of the substrate 110. The metal film 130 has a relatively small thickness. For example, in FIG. 1, the thickness of the portion of the metal film 130 is in a range from 1 nm to 1000 nm.

The first surface 112 of the substrate 110 is a rough surface provided with multiple fine uneven portions 120. Between the substrate 110 and the metal film 130, gaps 140 are dispersed toward the center direction of the substrate 110.

As illustrated in FIG. 2, an upper surface of the metal film 130 has a form such that sections 132 having “broccoli shapes” are positioned adjacent each other, and between the sections 132 of the corresponding “broccoli shapes,” a crack 150 is observed.

Note that it is possible that the shapes of the sections 132 are slightly different in appearance depending on shapes and distributions of the fine uneven portions 120; however, even for such a case, a point is in common such that the multiple sections 132 are adjacent each other through corresponding cracks 150, so that these are collectively referred to as the “broccoli shapes,” in this application.

When the metal film 130 is relatively thin, the cracks 150 are significantly observed as in FIG. 2, and the cracks 150 contribute to high transmittance of the layered product 100. However, when the metal film 130 is thick, such as greater than or equal to 200 nm, the cracks 150 are hardly observed, and thereby transmittance of the layered product 100 is reduced. In this manner, by the film thickness of the metal film 130, the transmittance of the layered product 100 can be controlled to a certain extent.

Note that in the example of the layered product 100 illustrated in FIG. 1, a relatively thin metal portion 135 exists immediately above the first surface 112 of the substrate 110.

The film of this thin metal portion 135 is formed when the metal film 130 is formed on the first surface 112, which is the rough surface provided with the multiple fine uneven portions 120, by not only covering the convex portions on the first surface 112 with the metal film 130, but also by covering the concave portions on the first surface 112 with the metal film 130 by causing the metal film 130 to go around the concave portions, so that the thin metal portion 135 has a shape provided with fine unevenness while tracing the first surface 112 of the substrate 110 to some extent. Furthermore, the metal film 130 and the thin metal part 135 are continuous, at least, at one portion. In that sense, the collection of the metal film 130 and the thin metal portion 135 can be said to be a single-layered metal film.

Here, the gaps 140 dispersed between the substrate 110 and the metal film 130 optically affect light in a visible light region. For example, by the existence of the gaps 140, a refractive index of the substrate 110 including the gaps differs from a refractive index of the substrate 110 alone. Furthermore, the visible light passing through the thin metal portion 135 from the side of the second surface 114 of the substrate 110 causes, in the gaps 140, optical interference between the metal film 130 and the thin metal portion 135, so that, when the layered product 100 is viewed from the second surface 114, there is an effect that the first layered product 100 appears to have an absorption color.

By the above-described effect by the gaps 140, in the first layered product 100, angular dependence of the colors that occurs when the first layered product 100 is viewed from the second surface 114 of the substrate 110 can be significantly suppressed.

Furthermore, on the first layered product 100, in order to cause the above-described effect, it suffices if a single-layered metal film is arranged on the roughened first surface 112 of the substrate 110. Here, the single-layered metal film refers to a collection of the above-described metal film 130 and thin metal portion 135. Consequently, for the first layered product 100, the manufacturing process can be significantly simplified.

Furthermore, the first layered product 100 has features that, when the layered product 100 is measured from the side of the second surface 114 of the substrate 110, an absorption ratio with respect to visible light (an average value in a range of wavelength from 400 nm to 700 nm) is greater than or equal to 50%, reflectance (an average value in a range of wavelength from 400 nm to 700 nm) is less than or equal to 40%, and brightness L* of a D65 light source in a visual field of 10 degrees is less than or equal to 70.

(The Components Forming the Layered Product According to the Embodiment of the Present Invention)

Next, the components forming the first layered product 100 are more specifically described. Note that, in the following description, for referring to the members, reference numerals that are the same as the reference numerals shown in FIG. 1 are used for clarity.

(The Substrate 110)

The substrate 110 may be formed of any material; when a certain extent of transmittance is required for the first layered product 100, a transparent or semitransparent material can be appropriately selected, and when no transmittance is required for the first layered product 100, an opaque material can be appropriately selected. For example, the substrate 110 may be formed of a glass or a resin.

For a case where the substrate 110 is formed of a glass, the composition of the glass is not particularly limited. The substrate 110 may be formed, for example, of a soda-lime silicate glass, an aluminosilicate glass, an alkali-free glass, and so forth.

For a case where the substrate 110 is formed of a resin, the resin may be a polyester resin, an acrylic resin, a polycarbonate resin, or a mixture of any two or more of them.

The size and shape of the substrate (and those of the layered product 100) are not particularly limited. The substrate 110 may have a thickness from 0.1 mm to 10.0 mm, for example. Furthermore, the shape of the substrate 110 may be, in addition to an approximate rectangular shape, an approximate circular shape, an approximately elliptical shape, and so forth.

(Surface Roughening)

At least a part of the first surface 112 of the substrate 110 is roughened. This roughened state of the surface is not particularly limited, as long as the gaps 140 having the above-described effect can be formed between the substrate 110 and the metal film 130. As a method of roughening a surface, a fine processing technique can be utilized, such as wet etching; dry etching, such as RIE; a sol-gel method; coating, such as chemical vapor deposition; laser processing; nanoimpringing; photolithography, and so forth.

For example, on the first surface 112 of the substrate 110, the fine uneven portions 120, such as those of illustrated in FIG. 1, may be formed. When the substrate 110 is formed of a glass, such fine uneven portions 120 may be formed, for example, by etching the surface of the glass with hydrofluoric acid. It suffices if the fine uneven portions 120 include concave portions having hollowed shape (overhangs) toward the side of the second surface 114 of the substrate 110. By the existence of the concave portions having such shapes, the gaps 140 can be dispersed between the substrate 110 and the metal film 130.

In the first surface 112 of the substrate 110, an arithmetic average roughness Ra may be within a range from 0.2 nm to 100 nm; and a 10-point average roughness Rz may be within a range from 2 nm to 50 μm. The arithmetic average roughness Ra is, for example, within a range from 0.5 nm to 60 nm; and, for example, within a range from 0.8 nm to 50 nm. The 10-point average roughness Rz is, for example, within a range from 3 nm to 20 μm.

(Chemical Strengthening Process)

For a case where the substrate 110 is formed of a glass, such a glass may be chemically strengthened. In this manner, strength of the substrate 110 can be enhanced.

(The Metal Film 130)

The type of the metal film 130 is not particularly limited. The metal film 130 may be formed of a metal, such as Ta (tantalum); Al (aluminum); Ni (nickel); Ag (silver); Si (silicon); Cu (copper); Ti (titanium); Cr (chromium); Mn (manganese); Fe (iron); Co (cobalt); Zn (zinc); Ga (gallium); Ge (germanium); Zr (zirconium); Nb (niobium); Mo (molybdenum); Pd (palladium); In (indium); W (tungsten); Pt (platinum); or Au (gold), etc. Alternatively, the metal film 130 may be formed of an alloy, such as NiCr or AgAu. By the type of the metal film 130, specifically, by a refractive index and an absorption ratio, the color of the layered product 100 is determined at the time of viewing the layered product 100 from the side of the second surface 114. Namely, it can be expected that the metal films having similar refractive indexes and similar absorption ratios present colors in the same system.

Note that, in material science, Si usually belongs to a category of “semimetals,” however, in the present application, in order to avoid complicating the description, it is assumed that Si belongs to “metals.” Accordingly, the metal film 130 may be formed of Si or an alloy of Si.

(Another Feature of the First Layered Product 100)

The whole surface of the substrate 110 at the side of the first surface 112 may be roughened, and a metal film 130 may be arranged on the surface of the substrate 110. Furthermore, by using a masking technique, the first surface 112 of the substrate 110 may be selectively or partially roughened and/or the metal film 130 may be selectively or partially formed. A part of the first surface 112 of the substrate 110 that is not roughened and on which the metal film 130 is arranged looks like a mirror. Additionally, a part of the first surface 112 of the substrate 110 on which the metal film 130 is not arranged looks to be in the color of the substrate 110, namely, looks transparent or opaque. By a combination of these, for example, three types of patterns, which are black, transparent, and silver (mirror), can be drawn on the same surface of the substrate 110.

(Another Layered Product According to the Embodiment of the Present Invention)

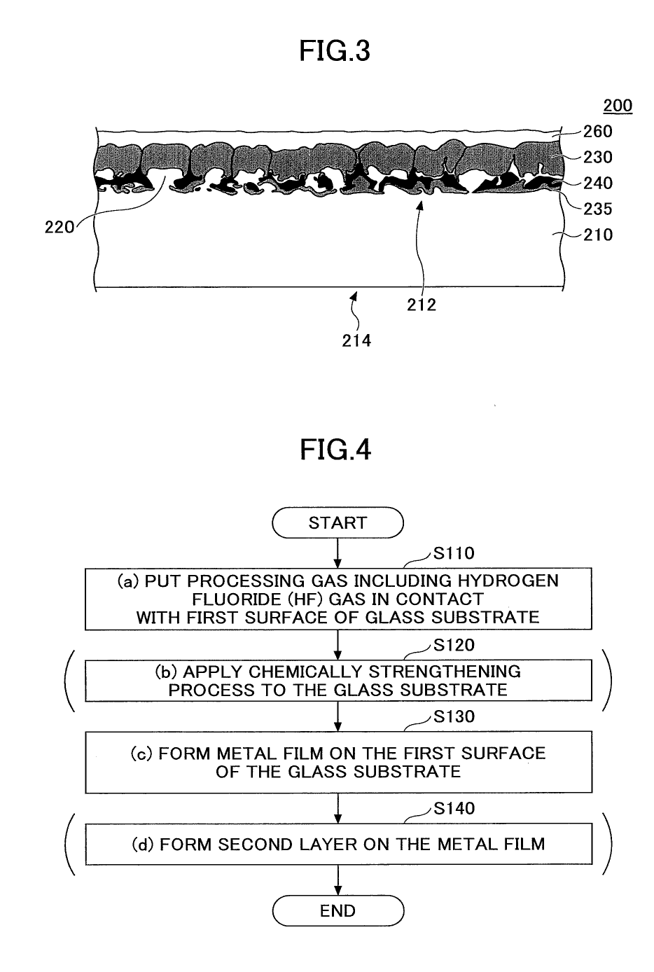

Next, by referring to FIG. 3, a configuration of another layered product (which is referred to as the “second layered product,” hereinafter) according to the embodiment of the present invention is described.

FIG. 3 schematically illustrates a cross section of the second layered product.

As illustrated in FIG. 3, basically, the second layered product 200 is provided with the same structure as the structure of the first layered product 100. However, the second layered product 200 differs from the first layered product 100 in a point that the second layered product 200 includes a second layer on the metal film. Namely, the second layered product 200 includes a substrate 210 provided with a first surface 212 and a second surface 214; a metal film 230 arranged at a side of the first surface 212 of the substrate 210; and a second layer 260 arranged on the metal film 230.

In the second layered product 200, gaps 240 are also dispersed between the substrate 210 and the metal film 230 in the direction to the center of the substrate 210. Consequently, for the case of the second layered product 200, characteristics and an effect can be obtained that are the same as the characteristics and the effect of the first layered product.

Furthermore, when the second layered product 200 is measured from the side of the second surface 214 of the substrate 210, for the second layered product 200, an absorption ratio with respect to visible light (an average value in a range of wavelength from 400 nm to 700 nm) is greater than or equal to 50%, reflectance (an average value in a range of wavelength from 400 nm to 700 nm) is less than or equal to 40%, and brightness L* of a D65 light source in a visual field of 10 degrees is less than or equal to 70.

In the second layered product 200 having such a structure, similar to the first layered product 100, angle dependence of the color that appears when the second layered product 200 is viewed from the side of the second surface 214 of the substrate 210 can be significantly suppressed.

Furthermore, for the case of the second layered product 200, in order to cause the above-described effect, it suffices if a single layered metal film 230 is arranged on the rough surface of the substrate 210. Here, the single-layered metal film refers to a collection of the above-described metal film 230 and the a thin metal part 235. Accordingly, the manufacturing process can be significantly simplified.

Here, the second layer 260 is formed of a material that differs from the material of the metal film 230. The second layer 260 is arranged so as to provide the second layered product 200 with at least one function. For example, by arranging the second layer 260, a protection function (humidity resistance, water resistance, and/or ultraviolet resistance), an anti-reflection function, a hard coat function, a transmittance (light concentration) adjustment function, a color adjustment function, a heat-ray reflecting function, and so forth of the metal film 230 can be obtained.

For example, if an environment resistance property of the metal film 230, such as corrosion resistance and water resistance, is not favorable, by arranging the second layer 260 having a favorable environmental resistance, such as corrosion resistance and water resistance, corrosion, degeneration, and/or deterioration of the metal film 230 can be suppressed.

The second layer 260 may be provided with, for example, an inorganic material (a dielectric material and/or a metal material), an organic material, or a combination thereof.

When the second layer 260 is formed of a dielectric material, the second layer 260 may be, for example, silicon nitride, silicon oxide, zinc oxide, tantalum oxide, titanium oxide, aluminum oxide, niobium oxide, ITO (indium tin oxide), titanium nitride, aluminum nitride, or gallium nitride, etc.

Furthermore, when the second layer 260 is formed of a metal, the second layer may be Ta, Ni, Si, Cu, Ti, Cr, Mn, Fe, Co, Zn, Ga, Ge, Zr, Nb, Mo, Pd, In, W, Pt, Au, or NiCr, etc.

When the second layer 260 is formed of an organic material, the second layer may be a thermosetting resin, a photosetting resin, a thermoplastic resin, or a hybrid material including an inorganic material and an organic material.

The method of forming the second layer 260 is not particularly limited. Furthermore, a film thickness of the second layer 260 is appropriately selected depending on the function to be presented.

(Method of Manufacturing the Layered Product According to the Embodiment of the Present Invention)

Next, by referring to FIG. 4, the method of manufacturing the layered product according to the embodiment of the present invention is described, which has the above-described characteristics.

Here, in particular, an example of the method of manufacturing the layered product according to the embodiment of the present invention is described by exemplifying a case where the glass substrate is used, as the substrate. However, it is apparent to a person ordinarily skilled in the art that the following manufacturing method can be applied as it is or by modifying a part of it for a case where a substrate other than a glass substrate is used.

FIG. 4 illustrates a schematic flow of the method of manufacturing the layered product according to the embodiment of the present invention (which is referred to as the “first manufacturing method,” hereinafter). As illustrated in FIG. 4, the first manufacturing method includes

(a) a process of putting a processing gas including a hydrogen fluoride (HF) gas in contact with the first surface of the glass substrate (step S110);
(b) a process of applying a chemically strengthening process to the glass substrate (step S120);
(c) a process of forming a metal film on the first surface of the glass substrate (step S130); and
(d) a process of forming a second layer on the metal film (step S140).

However, step S120 and step S140 are to be optionally performed, so that at least one of them may be omitted.

The steps are described below.

(Step S110)

First, a transparent or semitransparent glass substrate is prepared.

The type of the glass substrate is not particularly limited. For example, the glass substrate may be a soda-lime silicate glass, an aluminosilicate glass, or an alkali-free glass. However, when the chemically strengthening process is to be executed in the subsequent process (step S120), the glass substrate is required to include an alkali metal element.

The method of manufacturing the glass substrate is not particularly limited. The glass substrate may be manufactured, for example, by a float method.

The thickness of the glass substrate is preferably less than or equal to 10 mm; and, for example, the thickness of the glass substrate may be within a range from 0.3 mm to 3 mm. If the thickness of the glass substrate is greater than or equal to 10 mm, weight increases, and it becomes difficult to reduce weight; and further the cost of the raw material increases.

Here, blasting may be applied to at least one surface (the first surface) of the glass substrate. In this case, in the following “etching process,” the etching process is to be applied to the first surface of the glass substrate. However, blasting is not an essential step, so that blasting may not be performed.

Subsequently, the prepared glass substrate is exposed in the processing gas including a hydrogen fluoride (HF) gas; and the “etching process” of the glass substrate is performed.

Note that, in the present application, the etching process means a process of putting the processing gas including a hydrogen fluoride gas in contact with the surface of the glass substrate, regardless of the actual amount of etching. Thus, even if the actual etching amount of the process is very small (e.g., a level of a process of forming unevenness in the order from 0.2 nm to 100 nm when the unevenness is converted into the arithmetic average roughness Ra), such a process is included in the “etching process.”

This process is to be performed so as to form fine unevenness on the surface of the glass substrate. By the existence of the fine unevenness, gaps can be dispersed between the glass substrate and the metal film after following step S130.

The temperature of the etching process is not particularly limited; however, usually, the etching process is to be performed within a range from 400° C. to 800° C. The temperature of the etching process is preferably within a range from 450° C. to 700° C.; and more preferably within a range from 450° C. to 650° C.

Here, the processing gas may include, in addition to the hydrogen fluoride gas, a carrier gas and a dilution gas. As the carrier gas and the dilution gas, nitrogen and/or argon is used, for example, though the carrier gas and the dilution gas are not limited to these. Furthermore, water may be added.

The concentration of the hydrogen fluoride gas in the processing gas is not particularly limited, as long as the surface of the glass substrate is properly etched.

The concentration of the hydrogen fluoride gas in the processing gas is, for example, within a range from 0.1 vol % to 10 vol %; preferably within a range from 0.3 vol % to 5 vol %; and more preferably within a range from 0.5 vol % to 4 vol %. At this time, the concentration (vol %) of the hydrogen fluoride gas in the processing gas is obtained from the fluorine gas flow rate/(the fluorine gas flow rate+the carrier gas flow rate+the dilution gas flow rate).

The etching process of the glass substrate may be performed in a reaction vessel; however, if it is necessary, such as a case where the glass substrate is large, the etching process of the glass substrate may be performed in a state where the glass substrate is conveyed. In this case, compared to the process inside the reaction vessel, quicker and more efficient processing can be performed.

After the etching process, in the first surface of the glass substrate, the arithmetic average roughness Ra may be within a range from 0.2 nm to 100 nm; and the 10-point average roughness Rz may be within a range from 2 nm to 50 μm. The arithmetic average roughness Ra is, for example, within a range from 0.5 nm to 60 nm; and, for example, within a range from 0.8 nm to 50 nm. The 10-point average roughness Rz is, for example, within a range from 3 nm to 20 μm.

(Device Used for Etching Process)

Here, an example of a device that can be used for the etching process at step S110 is briefly described.

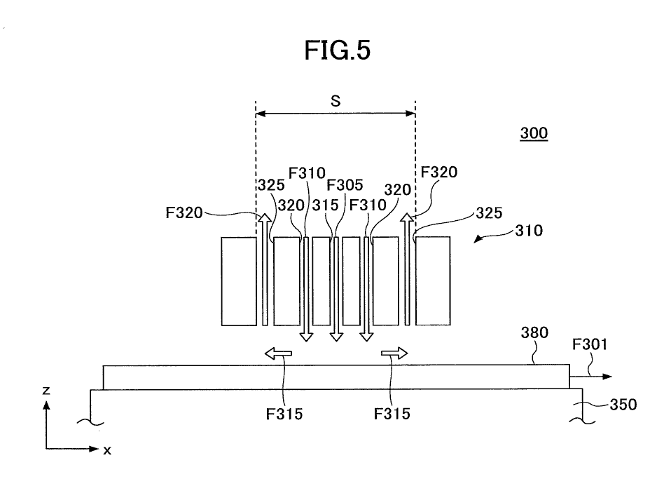

FIG. 5 illustrates an example of a configuration of a processing device that is used for performing the etching process of the glass substrate. The processing device illustrated in FIG. 5 can perform the etching process of the glass substrate in a state where the glass substrate is conveyed.

As illustrated in FIG. 5, the processing device 300 includes an injector 310; and a conveyance unit 350.

The conveyance unit 350 can convey the glass substrate 380 disposed on the upper portion in the horizontal direction (the X direction), as indicated by the arrow F301.

The injector 310 is located above the conveyance unit 350 and the glass substrate 380.

The injector 310 is provided with multiple slits 315, 320, and 325, which can be ventilation paths of the processing gas. Namely, the injector 310 includes the first slit 315 that is formed at the central portion along the vertical direction (the Z direction); the second slit 320 that is formed along the vertical direction (the Z direction) so as to surround the first slit 315; and the third slit 325 that is formed along the vertical direction (the Z direction) so as to surround the second slits 320.

One end (the upper part) of the first slit 315 is connected to a hydrogen fluoride gas source (not depicted) and a carrier gas source (not depicted); and the other end (the lower part) of the first slit 315 is directed toward the glass substrate 380. Similarly, one end (the upper part) of the second slit 320 is connected to a dilution gas source (not depicted); and the other end (the lower part) of the second slit 320 is directed toward the glass substrate 380. One end (the upper part) of the third slit 325 is connected to an exhaust system (not depicted); and the other end (the lower part) of the third slit 325 is directed toward the glass substrate 380.

For performing the etching process of the glass substrate 380 by using the processing device 300 formed in this manner, first, a hydrogen fluoride gas is supplied from the hydrogen fluoride gas source (not depicted) through the first slit 315 in the direction of the arrow F305. Furthermore, a dilution gas, such as nitrogen, is supplied from the dilution gas source (not depicted) through the second slit 320 in the direction of the arrow F310. These gases move in the horizontal direction (the X direction) along the arrow F315 by the exhaust system; and these gases are exhausted outside the processing device 300 through the third slit 325.

Note that, in addition to the hydrogen fluoride gas, a carrier gas, such as nitrogen, may be simultaneously supplied to the first slit 315.

Subsequently, the conveyance unit 350 is operated. Consequently, the glass substrate 380 moves in the direction of the arrow F301.

Upon passing through the lower side of the injector 310, the glass substrate 380 contacts the processing gas (the hydrogen fluoride gas+the carrier gas+the dilution gas) supplied from the first slit 315 and the second slit 320. In this manner, the surface of the glass substrate 380 is etched.

Here, the processing gas supplied to the surface of the glass substrate 380 moves along the arrow F315, and used for the etching process; and subsequently the processing gas moves along the arrow F320 and is exhausted outside the processing device 300 through the third slit 325 connected to the exhaust system.

By using such a processing device 300, etching of the surface by the processing gas can be performed while conveying the glass substrate. In this case, processing efficiency can be enhanced, compared to a method of performing the etching process by using a reaction vessel. Furthermore, for a case where such a processing device 300 is used, the etching process can be performed even for a large glass substrate.

Here, the rate of supplying the processing gas to the glass substrate 380 is not particularly limited. The rate of supplying the processing gas may be in a range from 5 SLM to 1000 SLM, for example. Here, SLM is an abbreviation of Standard Liter per Minute (a flow rate in a standard state). Furthermore, a time for the glass substrate 380 to pass through the injector 310 (a time for passing through the distance S of FIG. 5) is in a range from 1 second to 120 seconds; preferably in a range from 2 seconds to 60 seconds; and more preferably in a range from 3 seconds to 30 seconds. By adjusting the time for the glass substrate 380 to pass through the injector 310 to be less than or equal to 320 seconds, fast etching process can be performed.

In this manner, by using the processing device 300, the etching process can be applied to the glass substrate that is conveyed.

Note that the processing device 300 illustrated in FIG. 5 is merely an example; and the etching process of the glass substrate by the processing gas including the hydrogen fluoride gas may be performed by using another device. For example, in the processing device 300 of FIG. 5, the glass substrate 380 relatively moves with respect to the injector 310 that remains stationary. However, on the contrary, the injector 310 may be moved in the horizontal direction with respect to the glass substrate 380 that remains stationary. Alternatively, both the glass substrate 380 and the injector 310 may be mutually moved in opposite directions.

Furthermore, in the processing device 300 of FIG. 5, the injector 310 is provided with the three slits 315, 320, and 325 in total. However, the number of the slits is not particularly limited. For example, the number of the slits may be two. In this case, one slit may be used for supplying the processing gas (a mixed gas of the carrier gas, the hydrogen fluoride gas, and the dilution gas); and another slit may be used for exhausting. Furthermore, one or more slits may be formed between the slit 320 and the slit 325 for exhausting; and the etching gas, the carrier gas, and the dilution gas may be supplied.

Furthermore, in the processing device 300 of FIG. 5, the second slit 320 of the injector 310 is arranged so as to surround the first slit 315; and the third slit 325 is formed so as to surround the first slit 315 and the second slit 320. However, instead of this, the first slit 315, the second slit 320, and the third slit 325 may be arranged on a line along the horizontal direction (the X direction). In this case, the processing gas moves on the surface of the glass substrate along one direction; and, then, the processing gas is exhausted through the third slit 325.

Furthermore, multiple injectors 310 may be arranged along the horizontal direction (the X direction) on the conveyance unit 350.

By the above-described process, the first surface of the glass substrate is etched.

(Step S120)

Subsequently, if it is required, the chemically strengthening process is performed for the glass substrate that is etched.

Here, “chemically strengthening process (method)” refers to a collective term of a technique such that the glass substrate is immersed in a molten salt including an alkali metal, and an alkali metal (ion) having a small atomic diameter that exists on the outermost surface of the glass substrate is caused to be replaced with the alkali metal (ion) having a large atomic diameter that exists in the molten salt. In the “chemically strengthening process (method),” the alkali metals having the atomic diameters that are greater than the atomic diameters of the original atoms prior to processing are arranged on the surface of the processed glass substrate. Consequently, a compressive stress layer can be formed on the surface of the glass substrate, thereby enhancing the strength of the glass substrate.

For example, when the glass substrate includes sodium (Na), during the chemically strengthening process, sodium is replaced, for example, with potassium (K) in a molten salt (e.g., nitrates). Alternatively, for example, when the glass substrate include lithium (Li), during the chemically strengthening process, lithium may be replaced, for example, with sodium (Na) and/or potassium (K) in a molten salt (e.g. nitrates).

Conditions for the chemically strengthening process to be applied to the glass substrate are not particularly limited.

As types of the molten salt, there are, for example, alkali metal nitrates, alkali metal sulfates, alkali metal chloride salt, and so forth, such as sodium nitrate, potassium nitrate, sodium sulfate, potassium sulfate, sodium chloride, and potassium chloride. These molten salts may be used alone; or multiple types may be combined and used.

The processing temperature (the temperature of the molten salt) differs depending on the type of the molten salt to be used; however, the processing temperature may be in a range from 350° C. to 550° C., for example.

The chemically strengthening process can be performed, for example, by immersing the glass substrate in the molten potassium nitrate salt at temperature from 350° C. to 550° C. for about 2 minutes to 20 hours. From an economic and practical point of view, it is preferable that the chemically strengthening process is performed at the temperature from 350° C. to 550° C., and for 2 minutes to 20 hours.

In this manner, the glass substrate can be obtained such that a compressive stress layer is formed on the surface of the glass substrate.

As described above, step S120 is not an essential step. However, by performing the chemically strengthening process to the glass substrate, bending strength of the glass substrate can be enhanced.

(Step S130)

Subsequently, a metal film is formed on the first surface of the glass substrate, and a layered product is formed.

Conditions for forming the metal film is not particularly limited. The metal film may be formed, for example, by a dry film forming method, such as a sputtering method or a vapor deposition method; or by a wet film forming method, such as electroplating.

The thickness of the metal film is not particularly limited; however, for example, the thickness of the metal film is in a range from 1 nm to 1 μm. The thickness of the metal film may be in a range from 5 nm to 500 nm, for example. Note that, in the present application, the thickness of the metal film is defined to be a film thickness collectively including the thickness of the metal film 130 and the thickness of the thin metal portion 135 in FIG. 1. However, since the metal film thickness of the thin metal portion 135 is extremely small compared to the film thickness of the metal film 130, usually, the above-described thickness of the metal film is almost equal to the film thickness of the metal film 130.

The type of the metal film is not particularly limited. The metal film may be formed of a metal, such as Ta, Al, Ni, Ag, Si, Cu, Ti, Cr, Mn, Fe, Co, Zn, Ga, Ge, Zr, Nb, Mo, Pd, In, W, Pt, Au, etc. Alternatively, the metal film may be formed of an alloy, such as NiCr or AgAu.

As described above, the first surface of the glass substrate includes fine unevenness, which is generated by the etching process. Thus, after forming the metal film, dispersed gaps are formed between the first surface of the glass substrate and the metal film.

By the existence of the gaps, the refractive index of the substrate including the gaps differs from the refractive index of the substrate. Furthermore, when the light enters from the side of the second surface (the surface opposite to the first surface) of the glass substrate, the visible light that passes through the thin metal portion 135 causes optical interference between the metal film 130 and the thin metal portion 135 in the gaps, so that an effect is obtained such that, when the layered product 100 is viewed from the second surface 114, the layered product appears in an absorption color.

Consequently, in such a layered product, angular dependence of the colors can be significantly suppressed, which occurs when the layered product is viewed from the second surface of the glass substrate.

Note that the layered product has a feature such that, when the layered product is measured from the side of the second surface of the glass substrate, an absorption ratio with respect to visible light (an average value in a range of wavelength from 400 nm to 700 nm) is greater than or equal to 50%, reflectance (an average value in a range of wavelength from 400 nm to 700 nm) is less than or equal to 40%, and brightness L* of a D65 light source in a visual field of 10 degrees is less than or equal to 70.

(Step S140)

Subsequently, if it is required, a film of a second layer is formed on the metal film. Here, the second layer is formed of a material that is different from the material of the first layer.

As described above, the second layer may have any function, such as a protection function (humidity resistance, water resistance, light resistance, and/or ultraviolet resistance), an anti-reflection function, a hard coat function, a heat-ray reflecting function, and so forth of the metal film.

The second layer may be provided with, for example, an inorganic material (a dielectric material and/or a metal material), an organic material, and a combination thereof.

When the second layer is formed of a dielectric, the second layer may be, for example, silicon nitride, silicon oxide, zinc oxide, tantalum oxide, titanium oxide, aluminum oxide, niobium oxide, ITO (indium tin oxide), titanium nitride, aluminum nitride, gallium nitride, etc.

Furthermore, when the second layer is formed of a metal, the second layer may be Ta, Ni, Si, Cu, Ti, Cr, Mn, Fe, Co, Zn, Ga, Ge, Zr, Nb, Mo, Pd, In, W, Pt, Au, NiCr, etc.

When the second layer is formed of an organic material, the second layer may be a thermosetting resin, a photosetting resin, a thermoplastic resin, or a hybrid material including an inorganic material and an organic material.

A method of forming the film of the second layer is not particularly limited. Furthermore, the film thickness of the second layer is appropriately selected depending on a function to be presented.

By the above process, the first layered product 100 or the second layered product 200, such as that of illustrated in FIG. 1 or FIG. 3, can be manufactured.

### EXAMPLES

Next, examples of the present invention are described.

### Example 1

The layered product was manufactured by the following method, and the characteristics of the layered product were evaluated.

(Etching Process)

First, a transparent substrate formed of an alkali-free glass and having a thickness of 0.5 mm was prepared, which was manufactured by the float method. Here, a process, such as blasting, was not applied to the first and second surfaces of the transparent substrate.

Subsequently, an etching process by the HF gas was applied to the transparent substrate. For the etching process, the above-described processing device 300 illustrated in FIG. 5 was used.

In the processing device 300, a hydrogen fluoride gas and a nitrogen gas were supplied to the first slit 315, and a nitrogen gas was supplied to the second slit 320, so that the concentration of the HF gas was adjusted to be 3.6 vol %.

The exhaust amount from the third slit 325 was adjusted to be twice the total supply amount of the gases.

The transparent substrate was conveyed in a state where the first surface (the surface to be etched) was located at the upper side (the side closer to the injector 310: namely the processed surface), and the transparent substrate was heated to 580° C. Note that the temperature of the transparent substrate was a value that was measured for the same type of the transparent substrate in which a thermocouple was arranged, while conveying the transparent substrate under the similar heating conditions. However, the surface temperature of the transparent substrate may be measured by using a direct radiation thermometer.

The time for applying the etching process (the time for the transparent substrate to pass through the distance S in FIG. 5) was approximately 5 seconds.

By this process, the first surface of the transparent substrate was etched.

After the etching process, the surface roughness (Ra, Rz) of the first surface of the transparent substrate was measured based on JIS B0601 (2001), by using a scanning probe microscope (SPI3800N: produced by SII Nano Technology Inc.). As a result, the arithmetic average roughness Ra was approximately 200 nm.

Subsequently, a metal tantalum film (which is also simply referred to as a Ta film, hereinafter) was formed on the first surface of the transparent substrate, as a metal film.

The sputtering method was used for forming the Ta film. The film was formed by using a tantalum target, as the target, by using an argon gas (100%) as the introducing gas, and by setting the power density to be 0.4 W/cm². The degree of vacuum at the time of film formation was 0.5 Pa.

Note that, at the time of forming the film on the transparent substrate, a dummy glass substrate for measuring the film thickness was arranged in close proximity to the transparent substrate. In this dummy glass substrate, the surface on which the film was to be formed was smooth. After forming the film, the thickness of the Ta film formed on the surface of this dummy glass substrate was measured, and this thickness was adopted as the thickness of the Ta film on the transparent substrate. The thickness of the metal film was measured with Dektak 150 (produced by Vecco co.). As a result, the thickness of the Ta film was approximately 20 nm.

The layered product according to example 1 was manufactured by the above-described method.

### Example 2 Through Example 17

The layered products according to example 2 through example 17 were manufactured by the method similar to that of the above-described example 1. However, in these cases, the layered products were manufactured by varying the condition on the etching process and/or the type and thickness of the metal film, from the case of example 1.

### Example 18 and Example 19

The layered products according to example 18 and example 19 were manufactured by the method similar to that of above-described example 1.

However, in these examples, the thickness of the Ta film was adjusted to be 200 nm. Furthermore, after forming the Ta film, a film of a second layer was formed on the Ta film.

In example 18, by the sputtering method, a film of tantalum oxide was formed as the second layer. The film thickness of the second layer measured by the above-described method was 20 nm.

Furthermore, in example 19, by the sputtering method, a film of silica was formed as the second layer. The film thickness of the second layer measured by the above-described method was 20 nm.

### Example 20 and Example 21

The layered products according to example 20 and example 21 were manufactured by the method similar to that of above-described example 1.

However, for these examples, unlike the case of example 1, a soda-lime glass having a thickness of 0.5 mm was used as the transparent substrate. Furthermore, for these examples, the layered products were manufactured by using a condition on the etching process that is different from that of example 1, and by varying the film thickness of the Ta film.

### Example 22 and Example 23

The layered products according to example 22 and example 23 were manufactured by the method similar to that of above-described example 1.

However, for these examples, unlike the case of example 1, an aluminosilicate glass having a thickness of 0.5 mm was used as the transparent substrate. Furthermore, for these examples, the layered products were manufactured by using a condition on the etching process that is different from that of example 1, and by varying the film thickness of the Ta film.

### Example 24 and Example 25

The layered products according to example 24 and example 25 were manufactured by the method similar to that of above-described example 1.

However, for these examples, unlike the case of example 1, a soda-lime glass having a thickness of 0.7 mm was used as the transparent substrate. Furthermore, for these examples, sandblast processing was performed on the first surface of the soda-lime glass, prior to the etching process. Furthermore, for these examples, the layered products were manufactured by using a condition on the etching process that is different from that of example 1, and by varying the film thickness of the Ta film.

### Example 24 Through Example 28

The layered products according to example 24 through example 28 were manufactured by the method similar to that of above-described example 1.

However, for these examples, unlike the case of example 1, the etching process by the HF gas was not performed. Namely, by using the prepared transparent substrate as it was, the Ta film was formed on the first surface.

In example 26, the thickness of the Ta film was 40 nm; in example 27, the thickness of the Ta film was 100 nm; and in example 28, the thickness of the Ta film was 10 nm.

### Example 29

The layered product according to example 29 was manufactured by the method similar to that of above-described example 1.

However, for this example, unlike the case of example 1, the etching process by the HF gas was not performed. Namely, by using the prepared transparent substrate as it was, the Ta film (thickness was 6 nm) was formed on the first surface. Furthermore, by sequentially forming a silica film (thickness was 95 nm) and a second Ta film (thickness was 200 nm) on the Ta film, an optical multilayer film was formed.

The following Table 1 collectively shows the structure and manufacturing conditions of the layered products according to example 1 through example 29.

TABLE 1

| | | | | | Conditions on | | | | |
|---|---|---|---|---|---|---|---|---|---|
| | | | | | HF process | | | | |
| | | Transparent substrate | | Processing of | | HF | Metal film | | |
| | | | Thick- | surface of the | Temper- | concen- | | Thick- | |
| | Composition of | | ness | transparent | ature | tration | | ness | |
| Example | laminated body | Type | (mm) | substrate | (° C.) | (vol %) | Type | (nm) | Second layer |
| 1 | glass + metal film | alkali-free glass | 0.5 | HF process | 580 | 3.6 | Ta | 20 | — |
| 2 | glass + metal film | alkali-free glass | 0.5 | HF process | 580 | 3.6 | Ta | 40 | — |
| 3 | glass + metal film | alkali-free glass | 0.5 | HF process | 580 | 3.6 | Ta | 50 | — |
| 4 | glass + metal film | alkali-free glass | 0.5 | HF process | 580 | 3.6 | Ta | 100 | — |
| 5 | glass + metal film | alkali-free glass | 0.5 | HF process | 580 | 3.6 | Ta | 200 | — |
| 6 | glass + metal film | alkali-free glass | 0.5 | HF process | 580 | 3.6 | Ag | 10 | — |
| 7 | glass + metal film | alkali-free glass | 0.5 | HF process | 580 | 3.6 | Ag | 50 | — |
| 8 | glass + metal film | alkali-free glass | 0.5 | HF process | 580 | 3.6 | Al | 20 | — |
| 9 | glass + metal film | alkali-free glass | 0.5 | HF process | 580 | 3.6 | Al | 100 | — |
| 10 | glass + metal film | alkali-free glass | 0.5 | HF process | 580 | 3.6 | NiCr | 100 | — |
| 11 | glass + metal film | alkali-free glass | 0.5 | HF process | 580 | 3.6 | AgAu | 100 | — |
| 12 | glass + metal film | alkali-free glass | 0.5 | HF process | 580 | 3.6 | Si | 200 | — |
| 13 | glass + metal film | alkali-free glass | 0.5 | HF process | 580 | 3.6 | Cu | 280 | — |
| 14 | glass + metal film | alkali-free glass | 0.5 | HF process | 580 | 1.7 | Cu | 280 | — |
| 15 | glass + metal film | alkali-free glass | 0.5 | HF process | 580 | 1.2 | Cu | 280 | — |
| 16 | glass + metal film | alkali-free glass | 0.5 | HF process | 580 | 3.6 | Ti | 60 | — |
| 17 | glass + metal film | alkali-free glass | 0.5 | HF process | 580 | 1.2 | Ti | 60 | — |
| 18 | glass + metal film + | alkali-free glass | 0.5 | HF process | 580 | 3.6 | Ta | 200 | tantalum |
| | second layer | | | | | | | | oxide |
| 19 | glass + metal film + | alkali-free glass | 0.5 | HF process | 580 | 3.6 | Ta | 200 | silica |
| | second layer | | | | | | | | |
| 20 | glass + metal film | soda-lime glass | 0.7 | HF process | 580 | 1.8 | Ta | 200 | — |
| 21 | glass + metal film | soda-lime glass | 0.7 | HF process | 580 | 1.9 | Ta | 200 | — |
| 22 | glass + metal film | aluminosilicate glass | 0.7 | HF process | 580 | 2.1 | Ta | 100 | — |
| 23 | glass + metal film | aluminosilicate glass | 0.7 | HF process | 580 | 2.0 | Ta | 100 | — |
| 24 | glass + metal film | soda-lime glass | 0.7 | HF process | 580 | 1.9 | Ta | 40 | — |
| | | | | (after blasting) | | | | | |
| 25 | glass + metal film | soda-lime glass | 0.7 | HF process | 530 | 2.4 | Ta | 40 | — |
| | | | | (after blasting) | | | | | |
| 26 | glass + metal film | alkali-free glass | 0.5 | none | — | — | Ta | 40 | — |
| 27 | glass + metal film | alkali-free glass | 0.5 | none | — | — | Ta | 100 | — |
| 28 | glass + metal film | alkali-free glass | 0.5 | none | — | — | Ag | 10 | — |
| 29 | glass + multilayer metal film | alkali-free glass | 0.5 | none | — | — | Ta | 6 | silica* |

*Ta layer is formed on silica layer.

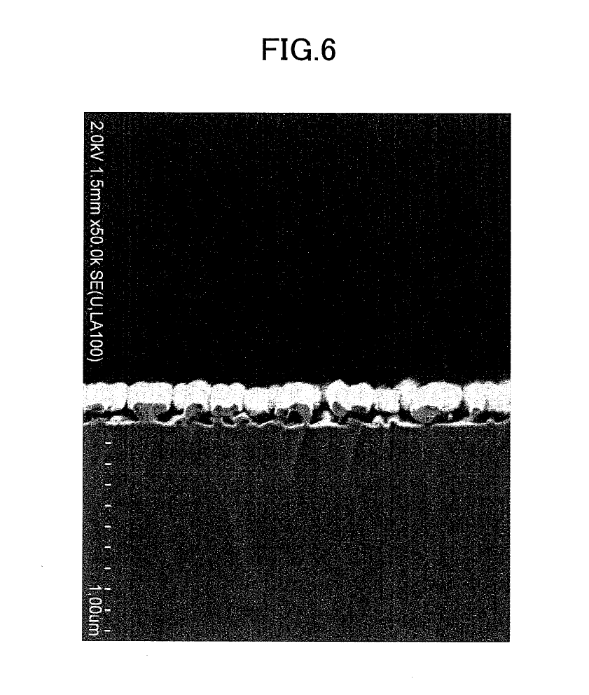

FIG. 6 shows, as an example, a SEM photograph of the cross section of the layered product according to example 4. From this figure, it can be seen that, for the case of the layered product according to example 4, the first surface of the transparent substrate is provided with fine unevenness (cf. a gray part in the photograph), and fine gaps (the black part of the photograph) are present and dispersed between the first surface and the metal film (the white part of the photograph).

For the case of the layered products according to example 1 through example 25, in any layered product, such a structure was observed. In contrast, in the layered products according to example 26 through example 29, the first surface of the transparent substrate was smooth, so that no gap was observed between the transparent substrate and the metal film.

(Evaluation)

By using the layered products according to example 1 through example 29, the following evaluation was performed.

(Measurement of Reflectance and Absorption Ratio)

In each of the layered products according to the examples, light was irradiated from the side of the second surface of the transparent substrate, and reflection behavior and absorption behavior were measured by using a spectrometry device (UV-3100PC: produced by Shimazu Corporation).

From the obtained results, the average reflectance R1 in the wavelength from 400 nm to 700 nm, and the average absorption rate A1 in the wavelength from 400 nm to 700 nm were obtained. Furthermore, the average reflectance R2 in the wavelength from 850 nm to 1500 nm, and the average absorption rate A2 in the wavelength from 850 nm to 1500 nm were obtained.

(Measurement of OD Value)

For each of the layered products according to the examples, Optical Density (OD) values were measured.

Here, the OD value indicates the light absorption degree of the layered product in the logarithmic scale, and it is represented by the following formula:

$$\begin{matrix}OD ( λ ) ( OD value ) = {Log}_{10} \{ T ( λ ) \text{/} I ( λ ) \} \\ = {Log}_{10} T ( λ ) - {Log}_{10} I ( λ )\end{matrix} \qquad formula ( 2 )$$

Here, (λ) is a wavelength, T(λ) is the amount of transmitted light in the wavelength band, and I(λ) is the amount of incident light in the wavelength band.

From formula (2), it can be said that the fact that the OD value is small indicates that the layered product easily transmits the light; and that, on the contrary, the fact that the OD value is large indicates that the layered product hardly transmits the light.

The OD value was measured by a monochrome transmission densitometer (ihacT5: Ihara Electronic Industries Co. Ltd.). Note that, in each layered product, the surface to be measured was the side of the second surface of the transparent substrate.

(Evaluation of Visually Observed Color)

Under a white fluorescent light environment, the color was determined at the time of viewing the layered product according to each of the examples from the side of the second surface of the transparent substrate. The viewing angle was set to an angle parallel to the normal line of the layered product.

(Evaluation of Color)

In the layered product according to each of the examples, the color was evaluated from the side of the second surface of the transparent substrate.

For the measurement of color, a color measurement device (colori7: Xrite Co., Ltd.) was used. Here, the obtained results were denoted by converting them into color coordinates L*a*b* in the visual field of 10 degrees of the D65 light source.

(Angular Dependence of Color)

For each of the layered products according to the examples, the angular dependence of color was evaluated.

The evaluation of the angular dependence of color was performed by using a spectrometry device (ARM-500N: produced by JASCO Corporation) as follows:

(1) in each layered product, light is irradiated from the side of the second surface of the transparent substrate in an angle tilted by 5 degrees with respect to the normal line of the layered product, and brightness of specular reflected light in 5 degrees was measured;
(2) similar measurement was performed for the tilt angle 45 degrees, and brightness of specular reflected light in 45 degrees was measured;
(3) the obtained brightness of the specular reflected light in 5 degrees was converted into color coordinates of the L*a*b* display system defined by JIS 28729, and the color coordinates L₁*a₁*b₁* were obtained. By applying the same conversion to the brightness of the specular reflected light in 45 degrees, the color coordinates L₂*a₂*b₂* were obtained.
(4) from the formula (3) below, a chroma difference ΔC was obtained:

ΔC=\sqrt{(a₁*)²+(b₁*)²}−\sqrt{(a₂*)+(b₂*)²} formula (3)

From formula (3), it can be seen that, as the difference between the color of the specular reflected light in 5 degrees and the color of the specular reflected light in 45 degrees becomes greater, the chroma difference ΔC becomes greater. Consequently, this chroma difference ΔC can be used as a measure that indicates the angular dependence of the color of the layered product.

Note that, at the time of the evaluation of the angular dependence of each of the layered products according to the examples, if the chroma difference ΔC was less than or equal to 9.5, a determination was made that “there was no angular dependence,” and if the chroma difference ΔC was greater than 9.5, a determination was made that “there was angular dependence.”

(Evaluation Result)

The evaluation results obtained for the layered products according to the embodiments are collectively shown in Table 2.

TABLE 2

| | Spectral characteristics | | Spectral characteristics | | | | | | | |
|---|---|---|---|---|---|---|---|---|---|---|
| | of visible light | | of visible light | | | | | | | |
| | 400 nm-700 nm | | 850 nm-1500 nm | | | | | | | |
| | Average | Average | Average | Average | | | | | | Angular |
| Ex- | reflectance | absorption | reflectance | absorption | OD | Observed | D65-10 | | | depen- |
| ample | R1 (%) | ratio A1 (%) | R2 (%) | ratio A2 (%) | value | color | L* | a* | b* | dence |
| 1 | 8.04 | 69.35 | 9.10 | 51.99 | 0.62 | black | 42.12 | 1.95 | 5.17 | none |
| 2 | 8.74 | 85.77 | 18.99 | 66.86 | 1.21 | black | 35.43 | 2.46 | 4.54 | none |
| 3 | 5.05 | 92.22 | 15.62 | 74.96 | 1.55 | black | 26.74 | 2.36 | −1.74 | none |
| 4 | 5.01 | 94.78 | 12.02 | 86.64 | 2.67 | black | 26.90 | 1.02 | −2.83 | none |
| 5 | 4.94 | 95.06 | 13.47 | 86.49 | 5.70 | black | 26.13 | 1.56 | −2.18 | none |
| 6 | 14.03 | 68.56 | 27.87 | 46.72 | 0.83 | purple | 51.22 | 9.17 | 17.15 | none |
| 7 | 17.96 | 80.10 | 42.34 | 53.52 | 1.81 | flesh color | 48.87 | 6.88 | 22.14 | none |
| 8 | 12.36 | 62.98 | 11.56 | 52.27 | 0.62 | gray | 51.75 | 1.16 | 7.19 | none |
| 9 | 8.57 | 89.50 | 19.02 | 76.04 | 1.66 | gray | 34.90 | 2.18 | 2.18 | none |
| 10 | 6.10 | 93.16 | 19.32 | 77.94 | 2.08 | black | 30.09 | 2.73 | 4.38 | none |
| 11 | 11.19 | 88.34 | 30.56 | 68.65 | 2.31 | dark brown | 40.55 | 3.93 | 8.37 | none |
| 12 | 12.32 | 86.38 | 32.63 | 18.32 | 2.82 | dark purple | 44.22 | 2.35 | 9.68 | none |
| 13 | 14.17 | 85.83 | 28.34 | 71.64 | 5.6 | dark brown | 45.35 | 10.37 | 16.31 | none |
| 14 | 18.84 | 81.16 | 45.62 | 54.36 | 6.10 | dark brown | 50.01 | 16.36 | 22.80 | none |
| 15 | 35.78 | 64.22 | 72.63 | 27.36 | 6.20 | dark brown | 65.78 | 14.73 | 16.45 | none |
| 16 | 7.37 | 89.15 | 18.95 | 69.88 | 1.52 | black | 32.67 | 3.25 | 3.73 | none |
| 17 | 19.40 | 78.61 | 35.45 | 58.15 | 1.67 | black | 52.28 | 2.61 | 8.41 | none |
| 18 | 6.44 | 93.56 | 15.49 | 84.47 | 5.40 | black | 29.56 | 2.08 | 1.43 | none |
| 19 | 6.74 | 93.26 | 15.78 | 84.21 | 6.70 | black | 32.29 | 1.36 | 1.13 | none |
| 20 | 9.70 | 90.30 | 18.78 | 81.18 | 4.46 | black | 38.65 | 1.39 | 4.64 | none |
| 21 | 4.97 | 95.01 | 10.25 | 89.72 | 5.10 | black | 27.13 | 1.27 | −1.32 | none |
| 22 | 6.30 | 93.54 | 9.56 | 89.62 | 2.85 | black | 29.75 | −0.07 | −6.04 | none |
| 23 | 9.03 | 90.78 | 22.04 | 76.86 | 2.89 | black | 35.05 | 1.92 | 3.39 | none |
| 24 | 15.95 | 77.42 | 19.49 | 68.94 | 1.21 | gray | 46.08 | 0.95 | 6.11 | none |
| 25 | 19.57 | 75.20 | 24.71 | 65.87 | 1.25 | gray | 52.41 | 1.01 | 8.05 | none |
| 26 | 43.04 | 54.87 | 48.99 | 47.58 | 1.55 | silver | 73.63 | 0.62 | 3.93 | none |
| 27 | 41.52 | 58.45 | 49.94 | 49.83 | 3.56 | silver | 73.04 | 0.42 | 3.97 | none |
| 28 | 61.69 | 11.78 | 82.24 | 11.98 | 0.49 | silver | 92.51 | −0.21 | 5.15 | none |
| 29 | 7.64 | 92.35 | 15.28 | 84.62 | 4.41 | black | 31.32 | 2.96 | −19.3 | exist |

From these results, it can be seen that, for each of the layered products according to example 1 through example 25, the average reflectance R1 is less than or equal to 20% and the average absorption rate A1 is greater than or equal to 60%, for the wavelength from 400 nm to 700 nm. In contrast, it can be seen that, for each of the layered products according to example 26 through example 28, the average reflectance R1 exceeds 40%, for the wavelength from 400 nm to 700 nm.

Furthermore, it can be seen that, for each of the layered products according to example 1 through example 25, the brightness L* of the D65 light source in the visual field of 10 degrees is less than or equal to 70; and, in contrast, for each of the layered products according to example 26 through example 28, the brightness L* of the D65 light source in the visual field of 10 degrees exceeds 70. In each of example 26 through example 28, the layered product looks like a mirror, so that both the reflectance R1 and the brightness L* are very large, the color is silver, and the color does not have angular dependence.

Furthermore, it can be seen that, for each of the layered products according to example 1 through example 25, the angular dependence is significantly suppressed, compared to the layered product according to example 29.

The structure of the layered product according to example 29 substantially imitates the structures of the layered products according to example 1 through example 25, except for the point that the fine unevenness is not formed in the surface of the transparent substrate. The visually observed color of the layered product according to example 29 was the same as the visually observed color of the layered product according to the embodiment of the present invention. However, the angular dependence was large for the layered product according to example 29 in such a manner that, for example, while the chroma difference LE for the layered product according to example 21 was 0.1, the chroma difference LE for the layered product according to example 29 was 9.9, which was large.

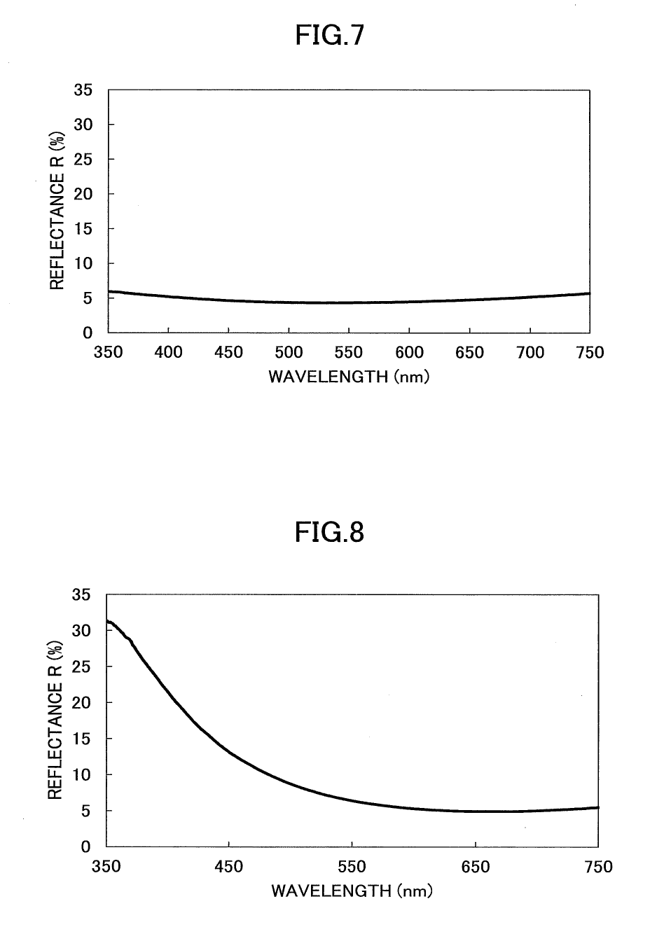

Here, color change caused by the angular dependence becomes significant for a case where the value of the reflectance R varies depending on the wavelength. Since the reflectance of the layered product according to the embodiment of the present invention (e.g., example 21) almost does not have wavelength dependence, the color of the layered product according to the embodiment of the present invention almost does not change, no matter from which position the layered product is viewed (FIG. 7). In contrast, a layered product obtained by forming an optical multilayer film on a flat substrate (e.g., example 29) exhibits large wavelength dependence, especially at the short wavelength side (FIG. 8). This is the main cause of occurrence of a large difference in the angular dependence of the color.

Note that, in order to obtain, on a flat substrate, an optical multilayer film having almost no wavelength dependence, such as that of described above, usually, many layers are required for the multilayer structure, such as 5 layers or 10 layers, and that is not realistic, in general, for the cost and for manufacturing. In this manner, it can be seen that, by arranging an optical multilayer film on a flat transparent substrate, the color can also be presented that is equivalent to the color of the embodiment of the present invention; however, in this case, the angular dependence of the color becomes large.

From above, it is confirmed that, in the layered product provided with the structure such that the fine gaps are dispersed between the transparent substrate and the metal film, the angular dependence of the color is significantly suppressed.

What is claimed is:

1. A layered product comprising:
a substrate, wherein the substrate includes a first surface and second surface that face each other,
wherein the layered product includes a metal film on a side of the first surface of the substrate,
wherein gaps are dispersed between the substrate and the metal film, the gaps optically affecting light in a visible light region,
wherein, when the layered product is measured from a side of the second surface of the substrate, an absorption ratio with respect to visible light, the absorption ratio being an average value in a range of wavelength from 400 nm to 700 nm, is greater than or equal to 50%, reflectance, the reflectance being an average value in a range of wavelength from 400 nm to 700 nm, is less than or equal to 40%, and brightness L* of a D65 light source in a visual field of 10 degrees is less than or equal to 70.

2. The layered product according to claim 1, wherein the substrate is formed of a glass.

3. The layered product according to claim 1, wherein the gaps are formed by etching the first surface of the substrate.

4. The layered product according to claim 1, wherein the metal film includes at least one metal or alloy selected from a group formed of Ta, Al, Ni, Cu, Cr, Si, Ti, Au, Ag, Mn, Fe, Co, Zn, Ga, Ge, Zr, Mo, Pd, In, W, Pt, and Nb.

5. The layered product according to claim 1, wherein, when the layered product is viewed from the side of the second surface of the substrate, the layered product presents a black color such that L* 50.

6. The layered product according to claim 1, wherein the layered product further includes a second layer on the metal film.

7. The layered product according to claim 6, wherein the second layer is formed of metal oxide, metal nitride, or a metal.

8. The layered product according to claim 1, wherein the metal film is a single layer film.
